(19) United States
(12) Patent Application Publication
(10) Pub. No.: US 2010/0149551 A1
(43) Pub. Date: Jun. 17, 2010

(54) Structured Light Imaging System and Method

(75) Inventor: Yuri Malinkevich, Shrewsbury, MA (US)

Correspondence Address: CANTOR COLBURN, LLP, 20 Church Street, 22nd Floor, Hartford, CT, 06103, US

(73) Assignee: FARO TECHNOLOGIES, INC., Lake Mary, FL (US)

(21) Appl. No.: 12/639,108

(22) Filed: Dec. 16, 2009

Related U.S. Application Data
(60) Provisional application No. 61/122,916, filed on Dec. 16, 2008.

(51) Int. Cl. G01B 11/24

(52) U.S. Cl. 356/603

(57) ABSTRACT

A structured light imaging system for measuring coordinates of a surface may include a first imaging lens, a spatial light modulator provided after the first imaging lens, a second imaging lens provided after the spatial light modulator, and an imaging sensor provided after that second imaging light modulator. A method of measuring coordinates of a surface using a structured light imaging system may include illuminating the surface with structured light from a projector and adjusting light intensity at each pixel of the imaging system by using a feedback loop system such that each pixel of the imaging sensor will operate in a linear response range.

### CROSS REFERENCE TO RELATED APPLICATIONS

This application claims the benefits of provisional U.S. Patent Application Ser. No. 61/122,916 filed on Dec. 16, 2008, the disclosure of which is hereby incorporated herein by reference in their entirely.

### FIELD OF INVENTION

The present invention relates generally to the field of metrology and imaging technology, and more specifically to the devices and methods of three-dimensional optical non-contact measurements, of physical dimensions of the objects; such as structured light based devices and systems.

### BACKGROUND OF INVENTION

Optical non-contact devices for measuring 3D dimensions of the objects, or more specifically, 3D coordinates of the object's surface, are known. Such devices have been developed in the past 10-20 years and are now readily available as products and are widely used in industry for process control and inspection, as well as in other applications, i.e. medical and heritage. Such devices, along with underlying technology, may include a structured light based devices (SLD) and systems (SLS).

As shown in FIG. 1, structured light metrology system consist of at least one projector 10, which projects a pattern 16 of dark and bright fringes on the surface of the measured object, and at least one imaging sub-system, usually based on CMOS or CCD camera 12 with an imaging lens 14, which images the surface that is illuminated by the projected fringes.

The SLS concept of measuring XYZ coordinates of points on the surface is based on solving a triangulation problem: each point on the object's surface can be uniquely identified by and associated with a certain projected fringe, or more specifically, with a phase of the fringe, as well as each and any point on the object's surface can be uniquely associated with a certain pixel on CCD or CMOS camera to which this point is imaged by the lens. The triangulation problem can easily be solved as each fringe is projected to a surface point at certain and known angle, as well as each surface point uniquely associated with other known angle, which is subtended by a line connecting this point with a particular pixel on CCD, as seen in FIG. 1.

In conventional structured light systems, the projector can be based on a laser, as a source of light, along with diffraction gratings or other components or subsystem, which serves as means to create structured light. For example, in U.S. Pat. No. 5,870,191 a projector for structured light system is disclosed, wherein a use of coherent light source, i.e. laser, in combination with mirrors and/or spatially positioned fibers are disclosed as the means for creating structured light, namely interference fringes, by utilizing interference effect of the coherent light.

In other conventional structured light systems an incoherent light is utilized, which can be generated by any known in the field light sources; such light source is usually a part of and is used with a conventional image projector, i.e. a type of projectors which are commonly used in conference rooms for presentations. These types of projectors, as well as the structured light systems based on them, are usually referred to as “white light” projectors (WLP) and systems (WLS) to segregate them the coherent light based SLS from white light base SLS. In WLS the projector can project different type of fringes, i.e. fringes with intensity that is distributed as sinusoidal function of coordinate, or fringes with intensity that is distributed as a periodic square function of the coordinate. Examples of WLS are the devices offered by GOM Corp., for example.

It is well known in the art of structured light technology that the metrological characteristics of any SLS, and specifically their achievable absolute accuracy, is dependent on how accurately the phase of the structured light or the phase of spatially distributed light intensity (SDLI) can be measured.

The temporal stability of the projected fringes or, more generally, of the SDLI is another limiting factor for repeatability and accuracy of the SLS.

In those structured light systems that have SDLI as a sinusoidal function of spatial coordinate, there are several well-known conventional technical solutions, which allow extracting the phase value of the projected fringes.

One of such solution is based on a so called phase shifting technique, which is a well known and commonly used technique in the art of interferometry, as well as in the art of SLS. A good review of known phase shifting algorithms can be found in the publications, such as chapter 5 of Holographic Interferometry (Pramod K. Rastogi, ed.)

In case of sinusoidal distribution of the structured light its intensity at each point (x,y) on the surface can be described as:

$$I ( x , y ) = {I}_{dc} + {I}_{ac} ( \frac{1}{2} + \frac{1}{2} cos [ φ ( x , y ) + Φ ( t ) ] ) \qquad ( 1 )$$

where:
I(x,y)—is the intensity of the projected to the surface fringes at the point with a coordinate (x,y);
I_{dc}—is a constant intensity of the light representing, for example, ambient light, which may get on the surface point (x,y) from the sources other than projector;
I_{ac}—is the max intensity of the light illuminated by the projector;
φ(x,y)—is the phase of the projected fringe at the point (x,y) on the surface, i.e., the measured object phase;
Φ(t)—is the phase shift in the sinusoidal fringe pattern; the phase shift can be introduced by many different techniques, which are well known in the art of interferometry, see for example, chapter 5 of Holographic Interferometry (Pramod K. Rastogi, ed.); and
t—is a parameter upon which the phase shift is dependent, for example, time.

There are number of algorithms that allow measurement of phase, Φ(x,y), of the projected fringes at any point (x,y) on the surface independently of the values of I_{dc} and I_{ac} see for example, chapter 5 of Holographic Interferometry (Pramod K. Rastogi, ed.). Below is an example of one of such algorithm, so called, four phases algorithm; the example is used there to illustrate the background of invention.

In any phase-shifting algorithm, four phases algorithm included, the measurement of phase Φ(x,y) is based on the measurement of the light intensity several times at the same point (x,y), each time after the phase of the sinusoidal fringes is shifted on a certain amount.

In the table below a specific example is given for the four phases algorithm: the values of intensity at a given point (x,y) are presented for the following phase shift values, Φ(t)=0, 90°, 180° and 270°, which are used in this particular algorithm. With having intensity of light measured for each of four phase values, namely, I₁(x,y), I₂(x,y), I₃(x,y) and I₄(x,y) at each (x,y) point, it is straight-forward to solve a system of four equations and get the value of the phase Φ(x,y) at each point (x,y).

| | | | | |
|---|---|---|---|---|
| I₁(x, y) = I_{dc} + I_{ac}cos[φ(x, y)] | φ(t) = | 0 | (0°) | (2) |
| I₂(x, y) = I_{dc} − I_{ac}sin[φ(x, y)] | = | π/2 | (90°) | |
| I₃(x, y) = I_{dc} − I_{ac}cos[φ(x, y)] | = | π | (180°) | |
| I₄(x, y) = I_{dc} + I_{ac}sin[φ(x, y)] | = | 3π/2 | (270°) | |

| i. | |
|---|---|
| $\begin{matrix}Tan [ φ ( x , y ) ] = \frac{{I}_{4} ( x , y ) - {I}_{2} ( x , y )}{{I}_{4} ( x , y ) - {I}_{2} ( x , y )} \\ ii .\end{matrix}$ | (3) |

Other conventional phase-shift technology algorithms are conceptually the same, and also based on measurements of the intensity with shifting phase.

It is important to mention that the phase-shift technology and associated algorithms are widely utilized in laser based SLS as well as in WLS systems.

It is also important to emphasize that it is CCD or CMOS devices that are most often, if not always, used as detecting device in SLS to capture the image of the surface, which is illuminated by the structured light from projector.

As is well known in the art (see ISO standard “ISO 14524:2009 Photography—Electronic still-picture cameras—Methods for measuring opto-electronic conversion functions (OECFs)” (hereinafter, ISO-14524), for example), any CCD or CMOS sensor has a limited dynamic range in its response to light, and sensor can easily be saturated with high enough light intensity so that the response of sensor will be specifically non-linear.

When CCD or CMOS sensors are used in SLS to measure intensity of the light, and subsequently determine the phases of the projected fringes, it is crucially important that the intensity of light, which is reflected from the surface and reaches the CCD or CMOS sensors, is in the range of the linear response of the sensor. In cases, when the light intensity is too high or too low, the signal from the corresponding pixels will be a non-linear function of the intensity, as it can be seen from the FIG. 2, which represents a typical Opto-Electronics Conversion Function (OECF) for CCD and CMOS (see ISO standard ISO-14524).

If light intensity is in the non-linear ranges of OECF then the direct application of phase-shifting methodology and corresponding formula, i.e. the formula (2) and (3) presented above for the four phase-shifts algorithm, would give grossly inaccurate results for the phase values, which in turn would lead to gross errors in the measurement results for XYZ coordinate of the surface points.

One conventional solution, which allows correcting to some degree the errors associated with the non-linearity of OECF response, is to build, so called, look-up table for the intensity values in non-linear range. By using a calibration procedure the look-up table can be established so that it will provide relationship between the CCD or CMOS electrical signal values for the intensity levels in non-linear range with the would-be signal values if the corresponding range had been linear, see FIG. 2.

FIG. 2 shows a typical opto-electrons conversion function for CCD or CMOS imaging sensors. Four typical ranges are shown: non-linear range for a low level of light intensity 100, linear range of response 102, non-linear range for high level of light intensity 104, and saturation range 106. The non-linear ranges can be linearized by building and utilizing look-up tables.

Linearization solution works and gives acceptable results only for a part of non-linear range of OECF. If the light intensity is close to saturation or in saturation range, where it is impossible to built a look-up table, the linearization solution is not applicable.

So the conventional structured light system are prone to errors or may even fail to measure accurately in many situation when measured surfaces has shiny, highly reflective areas, which would saturate pixels of CCD or CMOS, or when surfaces has very dark, low reflective surfaces, which would be imaged with a very low signal/noise ratio.

From the utility stand point it is highly desirable for SLS to be applicable for and capable of measuring any type of surfaces in terms of their reflectivity.

Another conventional solution to overcome this problem is to use a set of exposure times to accommodate for different reflectivity at different areas of the measured surface so that at least with one of exposure times the sensor would response in its linear range for an area of surface. This approach requires making a number of pictures/shots with different exposure times and then subjectively select the image data for different areas of surfaces so that the combined data would give a full image data with the intensity levels that fall in the linear range of sensor response.

As this solution requires taking multiple pictures it would lead to substantial increase in measurement time, which is very often undesirable.

Yet another conventional solution for the problem is to apply to the surface to be measured a special coating or paint to make the surface reflectivity uniform across the whole surface.

Although this approach gives a good image data it is very often appears to be either impractical or defeating the purpose of measurement as it is difficult to control the thickness of paint or coating.

Thus, it is desirable to create a system that overcomes the drawbacks of the structured light systems, namely, its deficiency in measuring accurately the surfaces, which has areas of highly different reflectivity or, for example, areas with highly specula reflection and diffusive reflection when surface is being illuminated by the projector of SLS.

### SUMMARY OF THE INVENTION

At least an embodiment of a structured light imaging system for measuring coordinates of a surface by measuring reflected structured light projected onto the surface by a projector may include a first imaging lens, a spatial light modulator provided after the first imaging lens, a second imaging lens provided after the spatial light modulator, and an imaging sensor provided after the second imaging light modulator.

At least an embodiment of a method of measuring coordinates of a surface using a structured light imaging system may include providing an imaging system including a first imaging lens, a spatial light modulator provided after the first imaging lens, a second imaging lens provided after the spatial light modulator, and an imaging sensor provided after the second imaging light modulator; illuminating the surface with structured light from a projector; and adjusting light intensity at each pixel of the imaging system by using a feedback loop system such that each pixel of the imaging sensor will operate in a linear response range.

### BRIEF DESCRIPTION OF THE DRAWINGS

Referring now to the drawings, exemplary embodiments are shown which should not be construed to be limiting regarding the entire scope of the disclosure, and wherein the elements are numbered alike in several figures:

FIG. 1 is a diagram showing a typical structured light system.

FIG. 2 shows an example of an opto-electrons conversion function.

FIG. 3 shows an embodiment of a triangulation concept for measuring 3D coordinates of the points on an object's surface.

FIG. 4 shows a general structured light system.

FIG. 5 shows an embodiment of an imaging system that includes a transparent spatial light modulator.

FIG. 6 shows an embodiment of an imaging system that includes a reflective spatial light modulator.

FIG. 7 shows an embodiment of an imaging system that includes a computer and feedback loops.

FIG. 8 is a flowchart showing a measurement process.

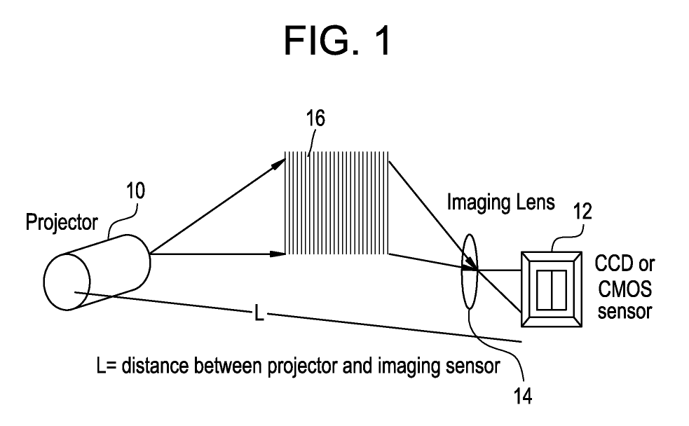

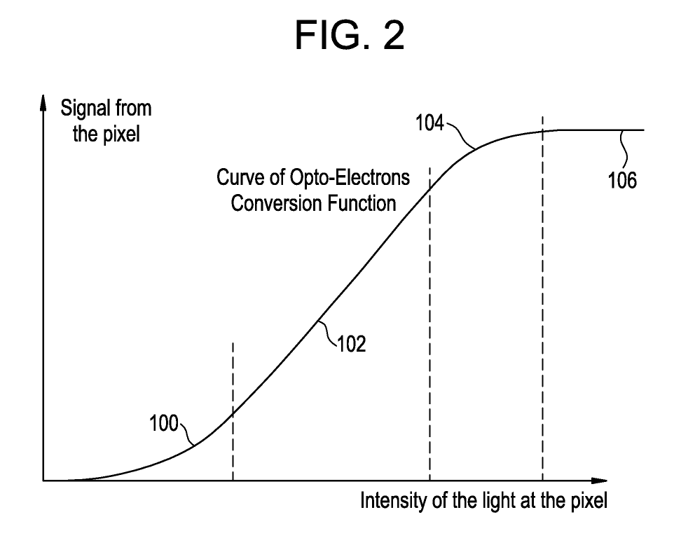

### DETAILED DESCRIPTION OF PREFERRED EMBODIMENTS

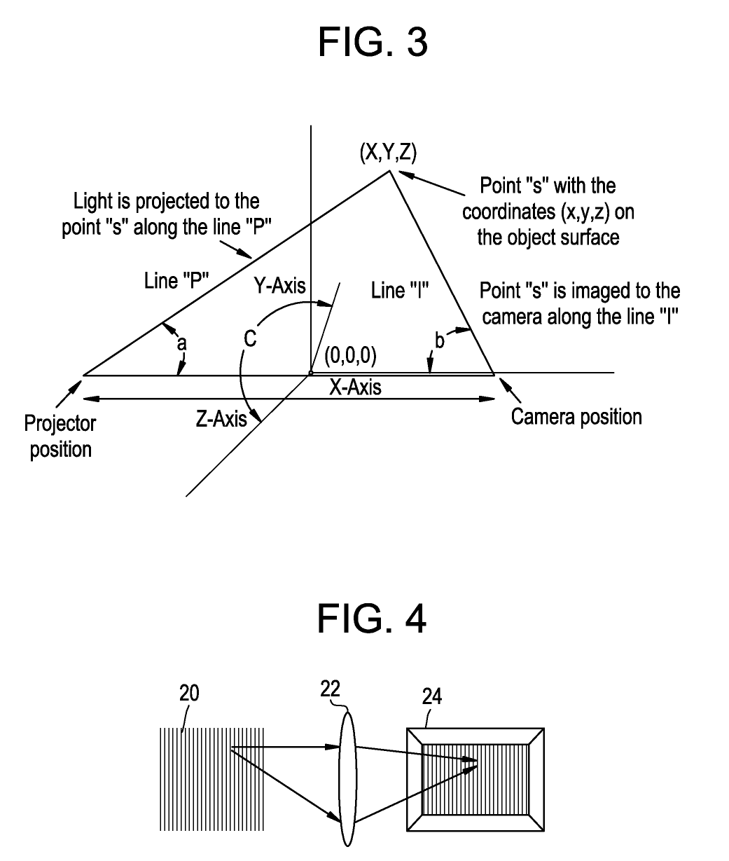

FIG. 3 shows a triangulation concept of measuring 3D coordinates of the points on an object's surface. In FIG. 3, L is the distance between the projector and the CCD or CMOS sensor. The light is projected to the point s on the object surface along the line P, and the same point s is imaged to the CCD/CMOS sensor along the line T

To solve the problem described above, the intensity of the light reflected from the measured surface will be controlled for each pixel of the CCD or CMOS sensor that is used in SLS.

A generic schematic of SLS is presented in FIG. 4, which illustrates that the light, after being projected to and then reflected from a point (x,y) on a measured surface 20, is collected to a certain pixel of CCD or CMOS array 24 by imaging lens 22.

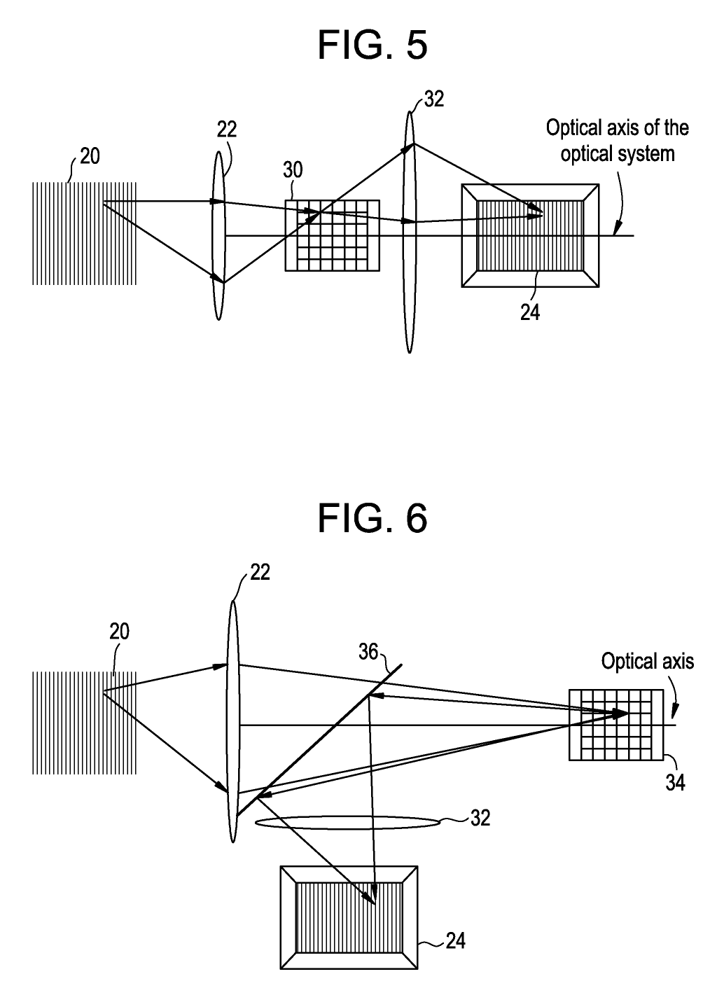

As shown in FIG. 5, a spatial light modulator (SLM) 30 can be positioned between the imaging lens and imaging sensor. The imaging sensor can be any appropriate light detecting device, such as CCD or CMOS devices or any other suitable device. Additionally, a second imaging lens, such as relay lens 32, can be positioned between the spatial light modulator and imaging sensor, where as the first imaging lens to be positioned in front of the spatial modulator.

The first imaging lens 22 should be positioned and chosen so that the image of the measured surface will be focused and sharply imaged on the plane of SLM 30. The second imaging lens 32, which is located between the SLM 30 and imaging sensor 24, should be positioned and chosen so that it will project the image, which is being created by first imaging lens 22 on the plane of SLM 30, to the pixel plane of the imager sensor 24.

FIG. 5 shows the proposed configuration for a translucent type of spatial light modulator. A translucent type of SLM can be a pixelated or non-pixelated device, and the SLM can control, at each point of its plane or at each or its pixel, the level of attenuation for the light going through it. Such SLMs are readily available, and are offered by several companies, for example by Holoeye Photonics AG (Germany), who offer a translucent SLM with 800×600 pixels, or by OnSet Corp., who offer a translucent Liquid Crystal based SLM with 820×640 pixels. Any other suitable SLM can also be used.

It is also proposed that the signal from each pixel of the imaging sensor 24, i.e. CCD or CMOS, is passed over to the computer to be processed so that the intensity of light, which is impinging each pixel of CCD or CMOS, can be measured. Such measurements can be accurately done by knowing OECF of the imaging sensor 24, i.e. CCD or CMOS; a standardized process of recording OECF is described in ISO standard ISO-14524;

It is also proposed that computer can control the translucency of each pixel of the spatial light modulator 30. In addition to this, a control software based on a suitable algorithm, can be used in the computer for the computer to set up the translucency of each pixel depending on the signal level from the pixels of imaging sensor 24, i.e. CCD or CMOS.

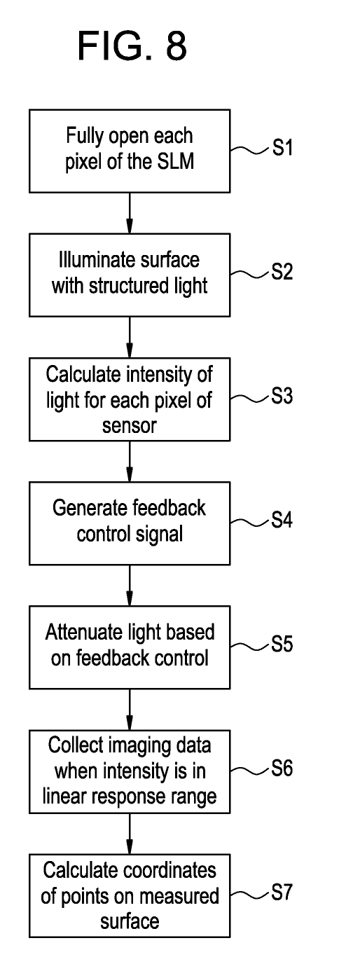

The measurement process with structured light system based on the proposed configuration will be performed as shown in FIG. 8 and described as follows:
a) at the very beginning of the measurement process each pixel of spatial light-modulator 30 to be set in fully opened or totally translucent state (step S1);
b) illuminate the measured surface 20 by the structured light from the projector. Any type of projector, such as laser based or white light base or any other suitable projector, can be used in the proposed configuration and solution (step S2);
c) read signals from each pixel of the imaging sensor 24 to the computer and evaluate the intensity of light that impinges each pixel (step S3);
d) utilize a feed-back control system, which is established by passing the signals from each pixel of imaging sensor to the computer, processing these signals by the feed-back loop software to generate control signals for each pixel of spatial modulator 30 (step S4), pass this control signals to the spatial modulator so that the translucency of each pixel of modulator will be getting adjusted until the signal level from the imager pixel will reach desirable level, i.e. level that corresponds to a linear range of OECF (step S5);
e) collect the imaging data as per the work flow of the of structured light system after having the translucency of each pixel of SLM 30 adjusted so that the light intensity at the pixels of imager sensor 24 falls in its linear range of OECF; an example of such work flow would be a collection of 4 images for different phase shifts as per four phase algorithm described above in the “Background of the invention” (step S6).
f) process data to deliver the (x, y, z) coordinate of the points on measured surface 30 (step S7).

The proposed imaging system can be utilized with any type of projector, and in addition this, it can be utilized with any overall configuration of SLS, for example an SLS which use one projector and several imaging sub-systems, an SLS with several projectors and one imaging system, or for any combination thereof, such as an SLS with several projectors and several imaging systems.

It is also proposed here that a reflective type of SLM can be used as well to achieve the same goal—the intensity level of the light that impinge to each pixel of the imaging sensor can be adjusted so that the imager sensor will work in a linear range of its OECF.

In case of using reflective SLM the imaging system can be configured as shown in FIG. 6. As seen in FIG. 6, the point on the measured surface is imaged to the reflective type of spatial modulator 34, which attenuates the intensity of the light. The light is reflected from reflective spatial modulator 34 to the beam splitter 36, which works as a folding mirror, and thereafter the light is focused to the corresponding pixel of sensor 24 by second imaging lens 32.

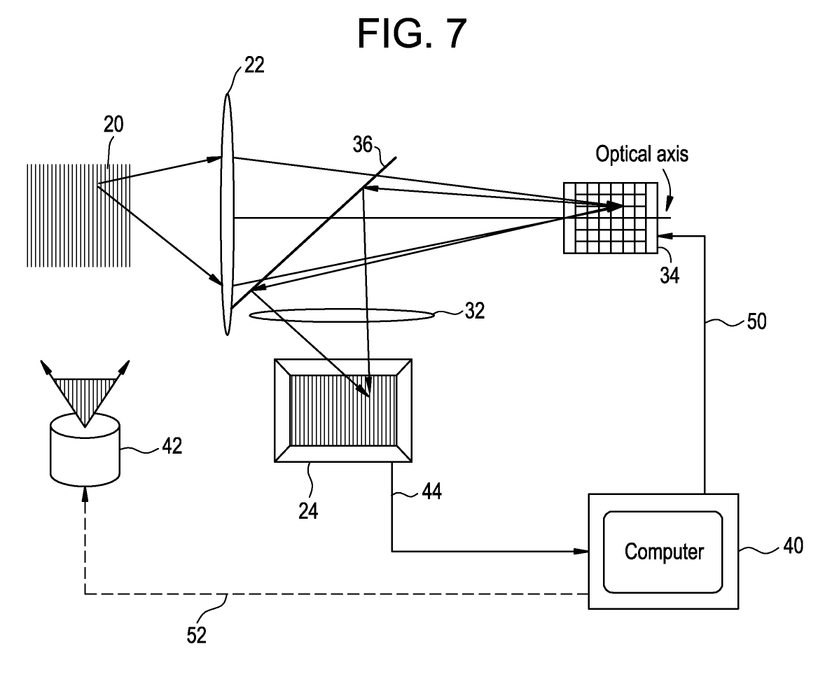

FIG. 7 shows an embodiment of an imaging system that includes a computer and feedback loops. As shown in FIG. 7, a signal or signals 44 can be sent from the imaging sensor 24 to the computer 40. Computer 40 can generate a control signal such as feedback signal 50 to control the spatial light modulator 34. This feedback signal 50 is created based on pre-set values defined by OECF of the imaging sensor 24 and by signals sent from imaging sensor 24 to computer 40. The feedback signal 50 can control spatial light modulator 34 to attenuate light at each point or pixel of spatial light modulator 34.

Computer 40 may also generate signals such as feedback signal 52 to control projector 42. These signals can control the intensity of the projected light at each pixel of the projector 42 if projector 42 is based on a pixilated device, for example, a Digital Light Projector that utilizes micro-mirrors to control intensity of the light at each pixel. In a laser-based projector, the intensity of projected light can be controlled by feedback signal 52 by controlling voltage or current of the laser or lasers.

Although FIG. 7 shows a computer and feedback signals for use with a reflective-type spatial modulator 34, it is not limited to this case. For example, it will be understood that a similar computer and feedback signals can also be used with a translucent-type spatial light modulator such as the example shown in FIG. 5.

With the proposed configuration for imaging system described above, which is applicable to and can be incorporated in any type of SLS, it is possible to achieve the following advantages:
a) measure surfaces, which have areas of very high and/or very low reflectivity, without the need to paint such surfaces or making multiple pictures with different exposure times
b) substantially reduce an overall time of measurements by reducing the number of pictures, virtually to just one to be taken; by taking just one picture after adjusting the light intensity for each pixel it would be sufficient data to achieve maximum accuracy.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed:

1. A structured light imaging system for measuring coordinates of a surface by measuring reflected structured light projected onto the surface by a projector, the imaging system comprising:
a first imaging lens;
a spatial light modulator provided after the first imaging lens;
a second imaging lens provided after the spatial light modulator; and
an imaging sensor provided after the second imaging light modulator.

2. The structured light imaging system of claim 1, further comprising a first feedback loop control system structured to control the spatial light modulator.

3. The structured light imaging system of claim 1, wherein the first imaging lens is structured to project an image of the object surface to a front plane of the spatial light modulator.

4. The structured light imaging system of claim 1, wherein the spatial light modulator is a translucent spatial light modulator.

5. The structured light imaging system of claim 2, wherein the spatial light modulator is structured to attenuate light at each point or pixel of the spatial light modulator based on a control signal from the first feedback loop control system.

6. The structured light imaging system of claim 5, wherein the light attenuated by the spatial light modulator is projected by the second imaging lens to the imaging sensor.

7. The structured light imaging system of claim 1, wherein the imaging sensor is a CCD or CMOS sensor.

8. The structured light imaging system of claim 5, wherein signals from each pixel of the imaging sensor are fed to a computer structured to compare levels of the signals from each pixel of the imaging sensor with pre-set levels; and
the control signal is set based on the comparison between levels of the signals from each pixel of the imaging sensor and the pre-set levels.

9. The structured light imaging system of claim 1 further comprising a second feedback loop control system structured to control intensity of the structured light projected by the projector;
wherein the second feedback loop control system is structured to control the intensity of the structured light based on a comparison between signals from pixels of the imaging sensor and pre-set signals.

10. The structured light imaging system of claim 1, wherein the spatial light modulator is a reflective spatial light modulator.

11. A method of measuring coordinates of a surface using a structured light imaging system, the method comprising:
providing an imaging system comprising:
a first imaging lens;
a spatial light modulator provided after the first imaging lens;
a second imaging lens provided after the spatial light modulator; and
an imaging sensor provided after the second imaging light modulator illuminating the surface with structured light from a projector; and
adjusting light intensity at each pixel of the imaging system by using a feedback loop system such that each pixel of the imaging sensor will operate in a linear response range.

12. The method of claim 11, wherein the adjusting light intensity comprises attenuating light with the spatial light modulator.

13. The method of claim 11, wherein the adjusting light intensity comprises controlling the intensity of the structured light projected by the projector.

14. The method of claim 11, further comprising recording images required for coordinate calculation when all of the pixels of the imaging sensor receive an intensity of light such that all of the pixels of the imaging sensor are operating in a linear response range.
